(19) United States
(12) Patent Application Publication
(10) Pub. No.: US 2021/0106496 A1
(43) Pub. Date: Apr. 15, 2021

(54) CPR FEEDBACK DEVICE

(71) Applicant: MEDICAL FEEDBACK TECHNOLOGY LTD, Rishon Letzion (IL)

(72) Inventors: Udi NAKAR, Rishon LeTzion (IL); Slav GAFT, Holon (IL)

(21) Appl. No.: 16/759,697

(22) PCT Filed: Oct. 28, 2018
(86) PCT No.: PCT/IL2018/051148

§ 371 Date: Apr. 27, 2020

(51) Int. Cl. A61H 31/00

(52) U.S. Cl. CPC A61H 31/005; A61H 31/007; A61H 2201/5048; A61H 2201/0157; A61H 2201/1645; A61H 2201/1635; A61H 2201/1654; A61H 2201/5061

(57) ABSTRACT

A medical device for lay rescuers and first aiders as part of “survival chain” in cardiac arrest scenario. The device gives audible feedback to its user regarding the adequate chest compression depth, based on American Heart Association (AHA) guidelines. In addition, it raises user's sense of capability and confidence in cases of cardiac emergencies.

CROSS-REFERENCED TO RELATED APPLICATIONS

This application is a National Stage entry of International Application No. PCT/IL2018/051148, filed on Oct. 28, 2018. The disclosure of the priority application is incorporated in its entirety herein by reference.

### FIELD OF THE INVENTION

A medical device for lay rescuers and first aiders as part of “survival chain” in cardiac arrest scenario. The device gives audible feedback to its user regarding the adequate chest compression depth, based on American Heart Association (AHA) guidelines. In addition, it raises user's sense of capability and confidence in cases of cardiac emergencies.

### BACKGROUND OF THE INVENTION AND PRIOR ART

Sudden cardiac arrest (SCA) refers to the sudden cessation of cardiac mechanical activity with hemodynamic collapse, usually occurs in patients due to coronary artery disease and patients with other cardiac problems such as arrhythmias, valvular abnormalities, congenital cardiac abnormalities etc. Irreversible brain damage occurs within 5 minutes from complete cardiac arrest.

According to the World health organization (WHO) data¹, collected in 2012, cardio vascular diseases are the leading cause of death worldwide, accounting for 17.5 million deaths yearly. Of these deaths, an estimated 7.4 million were due to Coronary heart disease (CHD) and 6.7 million were due to stroke. During a 38-year follow up of subjects in the Framingham Heart study², the annual incidence of sudden cardiac death increased dramatically with age and underlying cardiac disease.

Each year, approximately 350,000 out-of-hospital cardiac arrests occur in the US itself. Survival rates from SCA are less than 10% but can be doubled or even tripled if cardio-pulmonary resuscitation (CPR) is initiated by a bystander or EMS, respectively^{3,4}.

CPR is an emergency procedure that combines chest compressions and artificial ventilation (mouth-to-mouth or mechanical ventilation) that was first developed in the late 1950s and 1960s⁴. Delaying tissue death and preventing permanent brain damage by restoring partial flow of oxygenated blood to the brain and heart is its main goal. The onset of CPR and its quality are the main prognostic factors in the survival rates given above^{3,4,6}.

In 2010, AHA published its guidelines⁵ for CPR based upon extensive evidence performed by the International Liaison Committee on Resuscitation (ILCOR). The new guidelines were most notable for the conceptual change in the previously known CPR algorithm. The 2010 guidelines emphasized the importance of rapid identification of cardiac arrest and the importance of high quality chest compressions. The universal, well known CPR sequence has been reoriented from A-B-C (Airway-Breathing-Circulation) to C-A-B (Circulation-Airway-Breathing) as an expression of the importance of rapid initiation of chest compression and thus restoration of partial blood flow to the brain and heart, preventing irreversible damage. As for the quality of compressions, the AHA recommendations addressed the rate, depth and adequate recoil of the chest between compressions. Compression rate and depth were set to be at least 100/min and 2 inches (5 cm) respectively. According to the “Highlights of the 2010 guidelines for CPR and ECC” published by the AHA⁵, the given compression rate and depth, were associated with higher survival rates, while lower numbers were associated with lower survival rates. Compression fraction (the portion of time during which compressions are made, out of the total CPR time) was also mentioned in correlation with survival, advocating the importance of chest compressions in CPR^{5,9}.

For untrained bystanders, “Hands-only” (compression only) CPR algorithm was developed based on similar survival rates with either “Hands-only” CPR or CPR with both compressions and mouth-to-mouth ventilations. These findings were supported by many studies^{7,8}; however it's important to understand that compression-only CPR is only recommended for untrained rescuers while trained rescuers should adhere to the routine CPR and perform rescue breaths as well. Interestingly, in a large multicenter, randomized trial published by D. Rea et al. it was shown, that compression-only CPR increased survival rates among patients with cardiac cause of arrest and those with VF⁸.

### The Role of CPR in VF

Arrhythmic mechanisms, account for 20-35% of sudden cardiac deaths. Among these, Ventricular Fibrillation (VF) is responsible for the majority of episodes.

VF is a rapid, disorganized ventricular arrhythmia, resulting in no uniform ventricular contraction and thus impairment in cardiac output. Early defibrillation is an AHA (based on ILCOR) class 1 recommendation in cases of VF as data suggesting 8-10% decrease in survival with each passing minute¹⁰. Moreover, as the importance of immediate defibrillation has been substantiated, worldwide governmental laws have been enacted requiring placement of AEDs in public places.

Recent data suggested a 3 phase model for VF cardiac arrest referring the approximate time since cardiac arrest: (1) electrical phase, 0-4 min. (2) circulatory phase, 4-10 min. (3) metabolic phase, extending beyond 10 min. after cardiac arrest. Based on this model, the role of CPR in each phase has been studied. The “3 phase model” challenged the “uniform” way of treatment proposed by the AHA (immediate defibrillation regardless the time since cardiac arrest occurs)^{10,11}

During the electrical phase, immediate defibrillation indeed showed improvement in survival rates. The major conceptual change was regarding the circulatory phase in which chest compressions took priority over immediate defibrillation. It has been shown that delaying defibrillation by 1-3 minutes while providing oxygen delivery (chest compressions according to guidelines) results in higher success in terms of Return of Spontaneous Circulation (ROSC), hospital discharge and 1-year survival^{10,11}. The exact underlying mechanism is unknown although it is suggested that restoration of substrates as oxygen along with washout of deleterious metabolic factors accumulated during ischemia may explain the findings. As for the metabolic phase (>10 min after cardiac arrest), the extensive brain and cardiac cell injury may attenuate the survival benefit of CPR¹⁰. In general, regardless the time-to-shock discussed above, it is recommended to immediately resume adequate chest compressions following attempted defibrillation for two more min¹².

### Updated 2015 Guidelines

In 2015, the AHA updated its guidelines¹³. The previous concept of the importance of high quality chest compressions, presented in the 2010 guidelines, has been substantiated as more data became available¹⁶. Many studies have indicated higher survival rates from cardiac arrest for high quality chest compressions (adequate depth, rate, chest recoil etc.)

The main changes presented in the 2015 were in setting an upper limit for chest compressions rate and depth. For compressions rate, upper limit of 120/min was set suggesting that excessive rate may prevent an adequate chest recoil and impair the desirable compression depth. As for compressions depth, upper limit of 2.4 inches (6 cm) was set based on a report associating increased non-life-threatening injuries with excessive compression depth.

It is worth mentioning several things relating to the changes mentioned above:
i. The addition of an upper limit for compressions rate and depth was based on 1 publication each.
ii. In the 2010 guidelines, only 1 value for rate/depth was given suggesting that confusion may result when a range is recommended.
iii. Evaluating the precise depth of compression by an untrained bystander or even a trained rescuer may be challenging. With this in mind, the 2010 AHA recommended the concept of “Push Hard, Push Fast”. The new recommendations are inconsistent with the given statement and force a precise evaluation of a tight range (0.4 inches), which may be impossible in the absence of feedback devices. The extra precautions taken by a rescuer in avoiding deviation from the given range, may lead to inadequate compressions depth.

### Emerging Needs

Assessing CPR quality and adherence to the CPR guidelines was the objective of many studies and a high frequency of inadequate chest compression depth and rates compared to guidelines has been reported^{14,15}. Wik et al.¹⁴ studied the quality of CPR during out of hospital cardiac arrest and used the international CPR guidelines for outcome measure. In their study, Wik et al. used defibrillators to record chest compressions via a sternal pad fitted with an accelerometer. The mean compression depth was found to be 34 mm (95% Cl, 33-35 mm), 28% (95% Cl, 24%-32%) of the compressions reached 38-51 mm depth and more than half of the compressions were less than 38 mm.

Since the development of CPR in the late 1950s and its evolution through the years, the limited improvement in survival rates following cardiac arrest has led to the development of several CPR assisting devices. These devices were introduced to trained rescuers and are widely used nowadays (Bag and Mask ventilator, Cardio-Pump, Lucas CPR device etc.).¹⁷

Moreover, the importance of early initiation of CPR put focus on educating the general population regarding the subject and CPR assisting devices were also introduced to the “untrained” population targeting its needs (mobility, simplicity etc.).

The emphasis on the importance of chest compressions and the findings of inadequate chest compressions depth and rate, even among professionals, has led to further research and development of CPR feedback devices.

With the technological advances over the years, many assisting feedback devices have been developed based on different technologies (pressure sensors, accelerometers, metronomes) both for training and real life CPR. The efficacy of these devices became the subject of many studies.

A systemic review¹⁸ found evidence that feedback devices may be helpful for rescuers to improve CPR performance in both training and clinical setting. Yeung et al.¹⁹ conducted a single blinded, randomized controlled trial in which different feedback devices were compared. The primary outcome was compressions depth. Secondary outcomes were compression rate, proportion of chest compressions with inadequate depth, incomplete release and user satisfaction. The difference between the feedback devices was the technology used for its purpose. It was found that pressure sensor device improved compression depth (37.24-43.64mm, p-value=0.02) while the accelerometer device reduced chest compression depth (37.38-33.19mm, p-value=0.04).

Another open, prospective, randomized, controlled trial compared other CPR feedback devices found no significant improvement and the overall BLS quality was suboptimal in all groups.²⁰

To summarize, the studies described above and many others, studied the quality of chest compressions during CPR while little is known about the outcome and survival rates since the introduction of CPR assisting and feedback devices. One such study²¹ is now being conducted, assessing the effect of real-time CPR feedback and post event debriefing on patient's outcomes.

Since the evolvement of CPR assisting devices there has been an insignificant improvement in compressions quality and the survival rates following CPR on cardiac arrest victims remained constant^{20,22}. This may be explained, in our opinion, by several factors. First, the current studies regarding the existing CPR feedback devices used trained caregivers (EMS) or medical students as participants. This population is already well trained and major improvement in the quality of chest compressions was expected to be low. Regarding compression depth as an example, even if was suboptimal in comparison to the AHA guidelines, was probably better than compression depth achieved by lay population before arrival of trained teams. In the later, significant improvement in compressions quality is expected if feedback devices will be used. Secondly, the onset of high quality chest compressions is an important factor. As shown before, survival rates are doubled or even tripled if CPR is initiated before the arrival of EMS^{3,4}. These numbers may be even higher by improving the quality of chest compressions before arrival of EMS, by introducing feedback devices to first aiders and untrained population (12 million people are trained by the AHA annually). Such devices would also increase sense of capability among the general population when facing cardiac emergency as data from the AHA shows that 70% of Americans feel helpless to act in such cases.²³

Several principles should be taken into consideration when introducing such devices to the general population.
1. Affordable price (the proposed device is a lot cheaper than the existing devices)
2. Portable and small dimensional(the proposed device is a lot lighter and smaller than the existing devices)
3. Simplicity—no buttons or features that would confuse the user and/or postponed the initiation of CPR

The existing devices (CPR meter by Laerdal, Pocket CPR by Zoll etc.) use number of sensors and may give the exact compression depth, rate and other parameters associated with quality of CPR. Theoretically, these devices have had to make a meaningful change in quality of CPR and survival rates following cardiac arrest. Practically, their high price made them unaffordable by the general population and thus limited their potential. In the current outlines, these devices are excellent for training purposes.

### PRIOR ART

Due to the extensive need, many systems and devices have been introduced: U.S. 20170000688 to Kaufman et al; WO2016188780 to DELLIMORE et al; U.S. 20160317384 to Silver et al.; U.S. 20160256350 to Johnson et al; U.S. 20150105637 to Xuezhong Yu et al; U.S. 20150359706 to Bogdanowicz; U.S. 20130218055 to Fossan Helge ; U.S. Pat. No. 6390996 to Halperin et al; U.S. 20140323928 to Johnson Guy R; U.S. 20120184882 to Totman et al; and others.

None of the above systems or devices gives the practical solution to the problems described above.

The device introduced in this invention treats the problems and gives the optimal solution. The invention introduces a CPR feedback device that refers to the principles mentioned above. The Chest Compression Indicator is a small dimensional, easy for use, and cheap device that allows the user to get a real time feedback regarding CPR performed.

The device comprises a pressure sensor that transforms the pressure (weight) applied on a victim's chest into a desired depth and gives an audible output as a feedback.

A study published in 2006²⁴, provided comprehensive information concerning the elastic properties of the human chest during chest compressions and described the forces needed in order to achieve adequate compressions depth. According to this study, 50 kg force applied to the sternum would achieve adequate compression depth in most out-of-hospital cardiac arrest victims

Based on these findings, 50 Kg force as a gold standard was chosen, knowing that adequate depth would be achieved in most patients. It is also understood that in certain victims the sternum would be displaced more than 6 cm depth. Several concerns regarding consequences of deep compressions have been raised, thus the literature about chest compression complications was reviewed.

Various rates of skeletal and non-skeletal injuries were reported in several studies^{25,26}. In one study²⁷, the association of CPR-related thoracic and abdominal injuries and compression depth was investigated. According to this study, the incidence rate of injuries in mean compression depth categories <5 cm, 5-6 cm, >6 cm was 28%, 27%, 49% respectively. The correlation between compressions depth and related injuries was shown in males only, while no such association was observed in females. Nevertheless, the study concluded that the injuries were in by and large non-fatal and that it is important to remember that deeper compressions increase survival. The authors also mentioned that exaggerated fear of injuries related to deeper compressions depth would lead to a reduction in depth below recommendations. Even in the AHA 2015 guidelines, the addition of an upper limit to chest compression recommended depth was based on one publication that showed potential harm from excessive chest compression depth.

In the same document, it has been claimed that compression depth may be difficult to judge without use of feedback devices, and identification of lower and/or upper limit may be challenging.

It is believed that by reaching as many people as possible the sense of capability may be increased among general population and improve CPR initiated before arrival of EMS, thus increasing survival rates following cardiac arrest.

### REFERENCES

1. Cardiovascular diseases (CVDs) [Internet]. World Health Organization. 2017 [cited Feb. 4, 2017]. from: http://www.who.int/mediacentre/factsheets/fs317/en/2.
2. Kannel, W. B., & Thomas, H. E. (1982). Sudden coronary death: the Framingham Study. Annals of the New York Academy of Sciences, 382(1), 3-21.
3. Hasselqvist-Ax, I., Herlitz, J., & Svensson, L. (2015). Early CPR in Out-of-Hospital Cardiac Arrest. The New England journal of medicine, 373(16), 1573-1574.
4. Pozner, C. N., M D. (Jan. 19, 2017). Basic life support in adults. Retrieved Feb. 4, 2017, from https://www.uptodate.com/contents/basic-life-support-bls-in-adults?source=search_result&search=bls&selectedTitle=1˜40
5. Mary Fran Hazinski, RN, MSN. (2010). Hightlights of the 2010 American Heart Association Guidlines for CPR and ECC [Brochure]. Author
6. Podrid, P. J., MD. (n.d.). Prognosis and outcomes following sudden cardiac arrest in adults. Retrieved Feb. 4, 2017, from https://www.uptodate.com/contents/prognosis-and-outcomes-following-sudden-cardiac-arrest-in-adults?source=search_result&search=prognosis and outcomes following sudden cardiac arrest in adults&selectedTitle=1˜150
7. Hallstrom, A., Cobb, L., Johnson, E., & Copass, M. (2000). Cardiopulmonary resuscitation by chest compression alone or with mouth-to-mouth ventilation. New England Journal of Medicine, 342(21), 1546-1553.
8. Rea, T. D., Fahrenbruch, C., Culley, L., Donohoe, R. T., Hambly, C., Innes, J., . . . & Eisenberg, M. S. (2010). CPR with chest compression alone or with rescue breathing. New England Journal of Medicine, 363(5), 423-433.
9. Vadeboncoeur, T., Stolz, U., Panchal, A., Silver, A., Venuti, M., Tobin, J., . . . & Bobrow, B. (2014). Chest compression depth and survival in out-of-hospital cardiac arrest. Resuscitation, 85(2), 182-188.
10. Weisfeldt, M. L., & Becker, L. B. (2002). Resuscitation after cardiac arrest: a 3-phase time-sensitive model. Jama, 288(23), 3035-3038
11. Gilmore, C. M., Rea, T. D., Becker, L. J., & Eisenberg, M. S. (2006). Three-phase model of cardiac arrest: time-dependent benefit of bystander cardiopulmonary resuscitation. The American journal of cardiology, 98(4), 497-499.
12. Pierce, A. E., Roppolo, L. P., Owens, P. C., Pepe, P. E., & Idris, A. H. (2015). The need to resume chest compressions immediately after defibrillation attempts: an analysis of post-shock rhythms and duration of pulselessness following out-of-hospital cardiac arrest. Resuscitation, 89,162-168.
13. Neumar R W, Shuster M, Callaway C W, Gent L M, Atkins D L, Bhanji F, Brooks S C, de Caen A R, Donnino M W, Ferrer J M E, Kleinman M E, Kronick S L, Lavonas E J, Link M S, Mancini M E, Morrison L J, O'Connor R E, Sampson R A, Schexnayder S M, Singletary E M, Sinz E H, Travers A H, Wyckoff M H, Hazinski M F. Part 1: executive summary: 2015 American Heart Association Guidelines Update for Cardiopulmonary Resuscitation and Emergency Cardiovascular Care. Circulation. 2015; 132(suppl 2):S315-S367
14. Wik, L., Kramer-Johansen, j., Myklebust, H., S∅reb∅, H., Svensson, L., Fellows, B., & Steen, P. A. (2005). Quality of cardiopulmonary resuscitation during out-of-hospital cardiac arrest. Jama, 293(3), 299-304.
15. Abella, B. S., Sandbo, N., Vassilatos, P., Alvarado, j. P., O'hearn, N., Wigder, H. N., . . . & Becker, L. B. (2005). Chest compression rates during cardiopulmonary resuscitation are suboptimal. Circulation, 111(4), 428-434.
16. Ocal, O., Ozucelik, D. N., Avci, A., Yazicioglu, M., Aydin, Y., Ayvaci, B. M., . . . & Cukurova, Z. (201 5). A comparison of the outcome of CPR according to AHA 2005 ACLS and AHA 2010 ACLS guidelines in cardiac arrest: multicenter study. International journal of clinical and experimental medicine, 8(11), 21549.
17. Aygün, M., Yaman, H. E., Genc, A., Karadagli, F., & Eren, N. B. (2016). Mechanical Chest Compression Devices: Historical Evolution, Classification and Current Practices, A Short Review. Journal of Academic Emergency Medicine, 15(2), 94.
18. Kirkbright, S., Finn, J., Tohira, H., Bremner, A., Jacobs, I., & Celenza, A. (2014). Audiovisual feedback device use by health care professionals during CPR: a systematic review and meta-analysis of randomised and non-randomised trials. Resuscitation, 85(4), 460-471.
19. Yeung, J., Davies, R., Gao, F., & Perkins, G. D. (2014). A randomised control trial of prompt and feedback devices and their impact on quality of chest compressions—a simulation study. Resuscitation, 85(4), 553-559.
20. Zapletal, B., Greif, R., Stumpf, D., Nierscher, F. J., Frantal, S., Haugk, M., . . . & Fischer, H. (2014). Comparing three CPR feedback devices and standard BLS in a single rescuer scenario: a randomised simulation study. Resuscitation, 85(4), 560-566.
21. Perkins, G. D., Davies, R. P., Quinton, S., Woolley, S., Gao, F., Abella, B., & Cooke, M. W. (2011). The effect of real-time CPR feedback and post event debriefing on patient and processes focused outcomes: a cohort study: trial protocol. Scandinavian journal of trauma, resuscitation and emergency medicine, 19(1), 58.
22. Couper, K., Smyth, M., & Perkins, G. D. (2015). Mechanical devices for chest compression: to use or not to use?. Current opinion in critical care, 21(3), 188-194.
23. CPR Statistics. (2014, September 3). Retrieved Feb. 4, 2017, from http://heart.org/HEARTORG/CPRAndECC/Whatis%20CPR/CPRFactsandStat s/CPR-Statistics_UCM_307542_Article.jsp#.WJZReVN97IW
24. Tomlinson, A. E., Nysaether, j., Kramer-Johansen, j., Steen, P. A., & Dorph, E. (2007). Compression force-depth relationship during out-of-hospital cardiopulmonary resuscitation. Resuscitation, 72(3), 364-370.
25. Kim, M. J., Park, Y. S., Kim, S. W., Yoon, Y. S., Lee, K. R., Lim, T. H., . . . & Chung, S. P. (2013). Chest injury following cardiopulmonary resuscitation: a prospective computed tomography evaluation. Resuscitation, 84(3), 361-364.
26. Kashiwagi, Y., Sasakawa, T., Tampo, A., Kawata, D., Nishiura, T., Kokita, N., . . . & Fujita, S. (2015). “Computed tomography findings of complications resulting from cardiopulmonary resuscitation” Resuscitation, 88, 86-91.
27. Hellevuo, H., Sainio, M., Nevalainen, R., Huhtala, H., Olkkola, K. T., Tenhunen, J., & Hoppu, S. (201 3). “Deeper chest compression-more complications for cardiac arrest patients?” Resuscitation, 84(6), 760-765.

### SUMMARY OF THE INVENTION

A medical device that targets lay rescuers and first aiders as part of the “survival chain” in cardiac arrest scenario. The product gives audible feedback to its user regarding the adequate chest compression depth, based on the American Heart Association guidelines.

The device is a small portable device, built to fit between user's palm and patient chest. A bystander who carries the device applies it on the middle of patient's chest as shown in a picture printed on top of the device. The user receives audible feedback with every correct chest compression provided; otherwise, the device stays silent.

The user is motivated to achieve the audible feedback and to keep it through the entire CPR till the arrival of EMS.

Device's upper part is made of soft concave material (like for example, rubber) (soft upper pad) to ergonomically fit user's palm. The soft material is glued to a plastic cover. A picture or a schematic drawing on its upper part describes the correct place on patient chest where the device is to be placed.

Under the first soft layer a hard-upper lid is located. That lid may be manufactured by a three-dimensional printer. The material of the lid has to be of a solid material capable of enduring the high pressure inflected on the device when performing the CPR.

The lid connects to the other parts of the device by a single screw and by a rotatory closing system.

A printed electronic circuit (PCB) is located under the plastic lid. On top of which electronic components are assembled. The circuit connects to a hard lower lid by two screws.

The hard lower lid is made of same material and is similarly manufactured as the hard upper lid, on which the printed electronic circuit is placed.

On the side of the hard lower lid an FSR sensor is attached. The sensor is located in a niche of up to 0.5 millimeter on the rear side of the hard-lower lid in order to isolate the sensor from any contact with the cushion, herein under described, to avoid electric current for saving buttery.

The cushion which is made of soft concave material is located in the lower part of the device and is in contact with patient's chest. The inner part of the cushion, which has no contact with patient's chest, is located about a millimeter away from the sensor. When causing the pressure on patient's chest, the cushion is compressed and touches the FSR sensor. The contact with the sensor activates the electric circuit.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1—External view of the device.

FIGS. 2a-2f—Layout of device's parts.

FIG. 3—Location of FSR sensor

FIGS. 4a-4c—Internal view of device in open cut.

FIGS. 5a-5b—Lower silicone cushion inner.

FIG. 6—Schematic print of circuit board (PCB).

FIG. 7—electrical components.

FIG. 8—FSR sensor description.

FIG. 9—FSR sensor diagram

FIG. 10—Sensor Characteristics

FIG. 10—Spatial structural change of circular concave elevation

FIG. 11—Silicone adapter

### DETAILED DESCRIPTION OF THE PREFERRED EMBODIMENTS

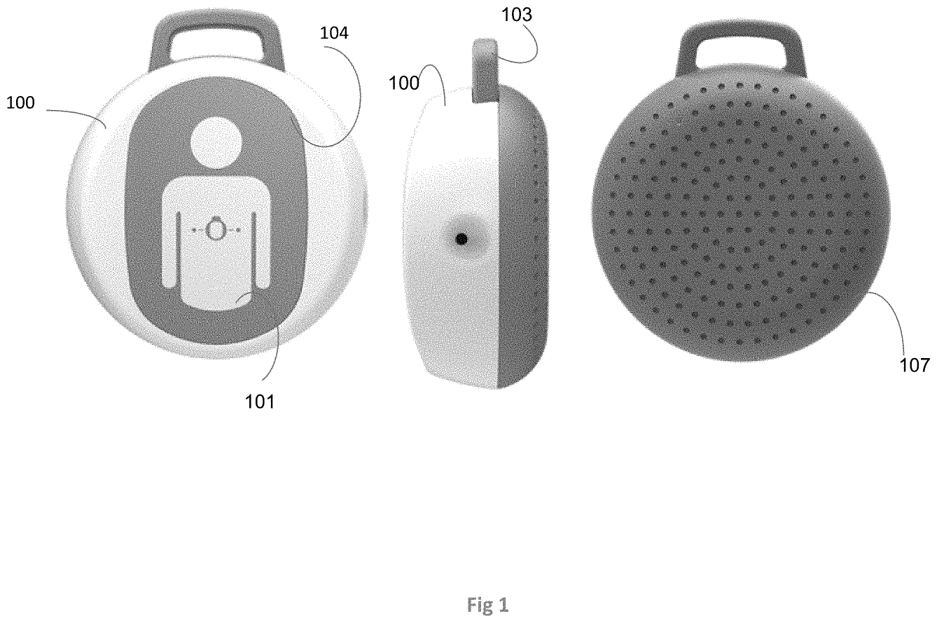

The device is a small portable device, (approximately D: 50 mm; thickness 24 mm; height 57 mm), built to fit between user's palm and patient chest (FIG. 1). A bystander who carries the device applies it on the middle of patient's chest as shown in picture/schematic drawing 101. The user receives audible feedback with every correct chest compression provided; otherwise, the device stays silent.

Device's upper part, soft upper pad 104, (FIG. 1) is made of soft material, (like, for example, rubber), to ergonomically fit user's palm. The soft upper pad 104 is glued to solid upper cover 100. Picture/schematic drawing 101 which is placed on upper pad 104 describes the correct place on patient chest where the device is to be placed.

A solid upper lid 100 is located under upper pad 104. That lid may be manufactured by plastic injection into a pre-designed mold. The material of the lid has to be of a solid material capable of enduring the high pressure inflected on the device when performing the CPR.

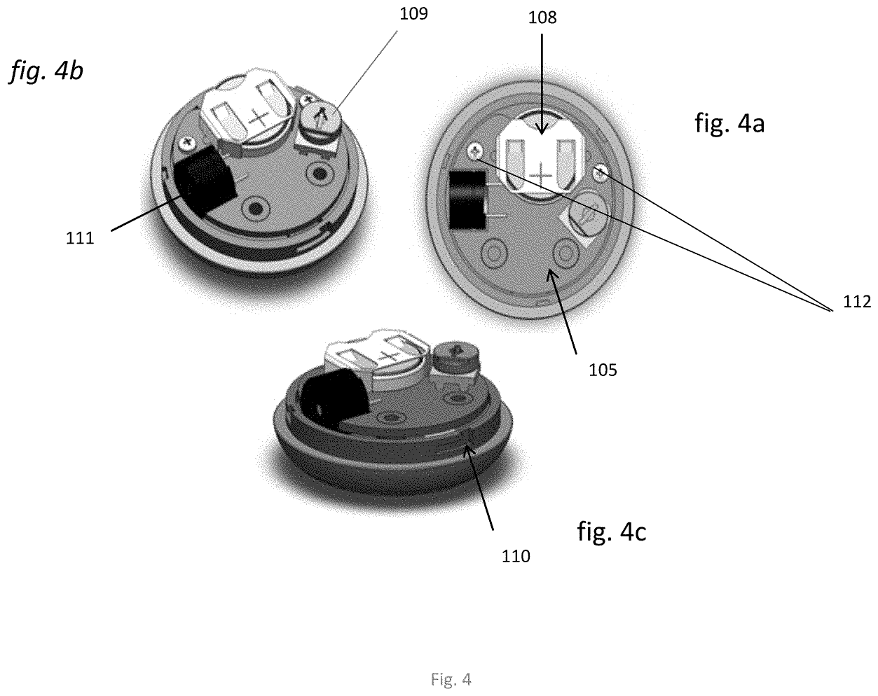

Upper lid 100 connects to the other parts of the device by a single screw and by a rotatory closing system 110 (FIG. 4c).

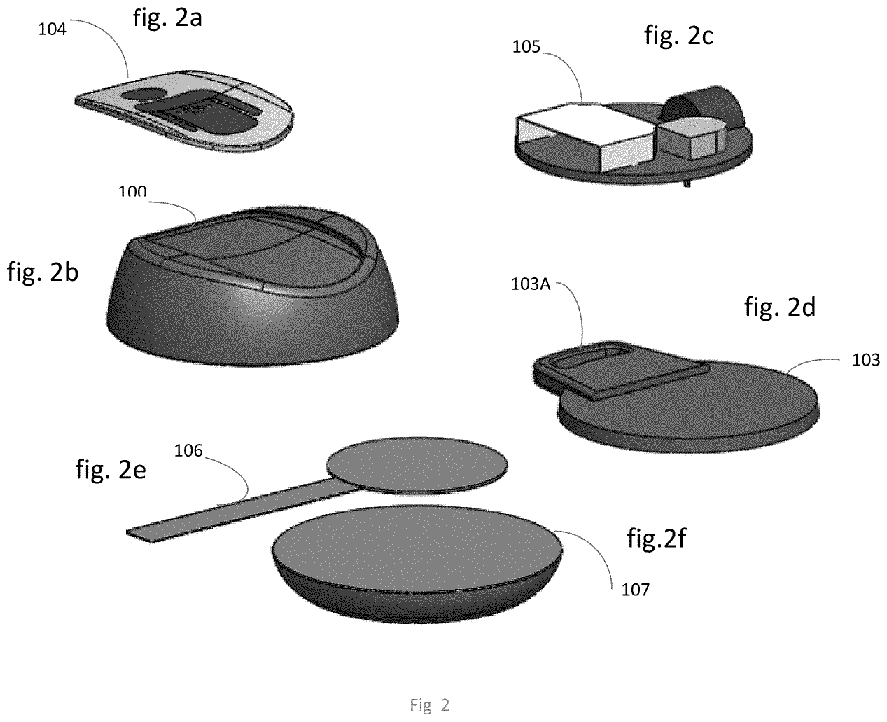

A printed electronic circuit 105 (PCB) (FIG. 2c) is located under plastic lid 100 (FIGS. 2b and 2c). On top of which electronic components are assembled (FIG. 2c). The circuit connects to a hard-lower lid 103 by two screws 112 (FIG. 4a).

Hard lower lid 103 is made of solid material similar to the material of solid upper lid 100 and may also be manufactured by plastic injection into a pre-designed mold. Electronic circuit 105 is printed on lower lid 103 (FIG. 2d).

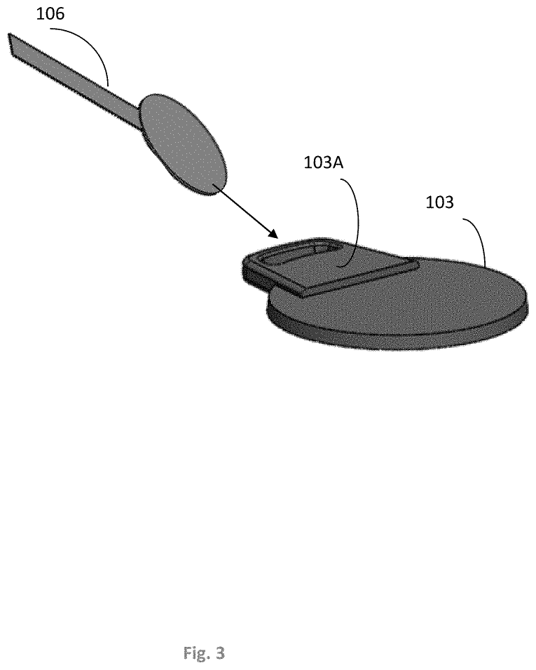

FSR sensor 106 (FIG. 2e) is attached to the rear side of hard lower lid 103. Sensor 106 is inserted into a niche of about 0.5 millimeter 103A on the rear side of hard lower lid 103 (FIG. 3), in order to isolate sensor 106 from any contact with cushion 107 to avoid electric current to save buttery 108 (FIG. 4a).

Cushion 107 (FIG. 2f) which is made of soft concave material is located in lower part of the device and is in contact with patient's chest. The inner part of cushion 107, which has no contact with patient's chest, is located about 0.5 mm away from sensor 106. When causing the pressure on patient's chest, cushion 107 is compressed and touches FSR sensor 106. The contact with the sensor activates the electric circuit.

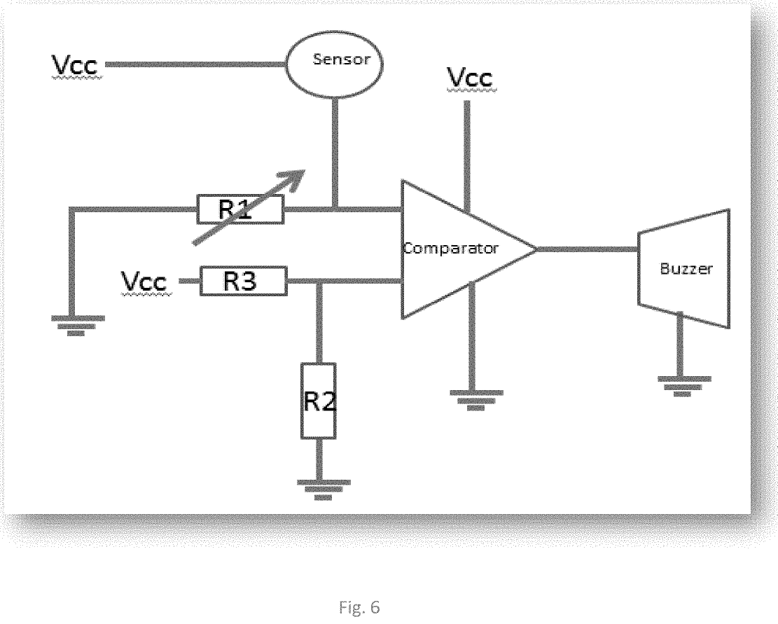

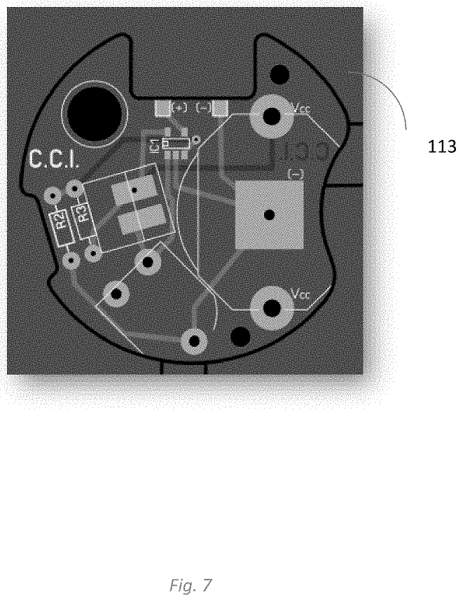

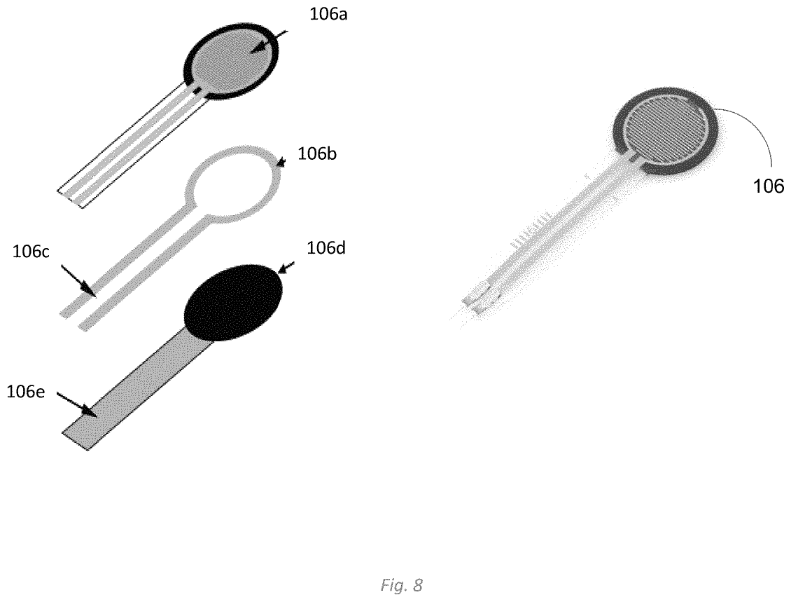

PCB 105 has 3 parts (FIG. 4a):
(1) Comparator 109 compares one analogue voltage level with another analogue voltage level or some preset reference voltage, VREF and produces an output signal based on this voltage comparison. In other words, the op-amp voltage comparator compares the magnitudes of two voltage inputs and determines which is the larger of the two (FIG. 6).
(2) Printed circuit 113 (FIG. 7).
(3) Force-sensitive resistor (FSR) sensors 106 (FIG. 8).

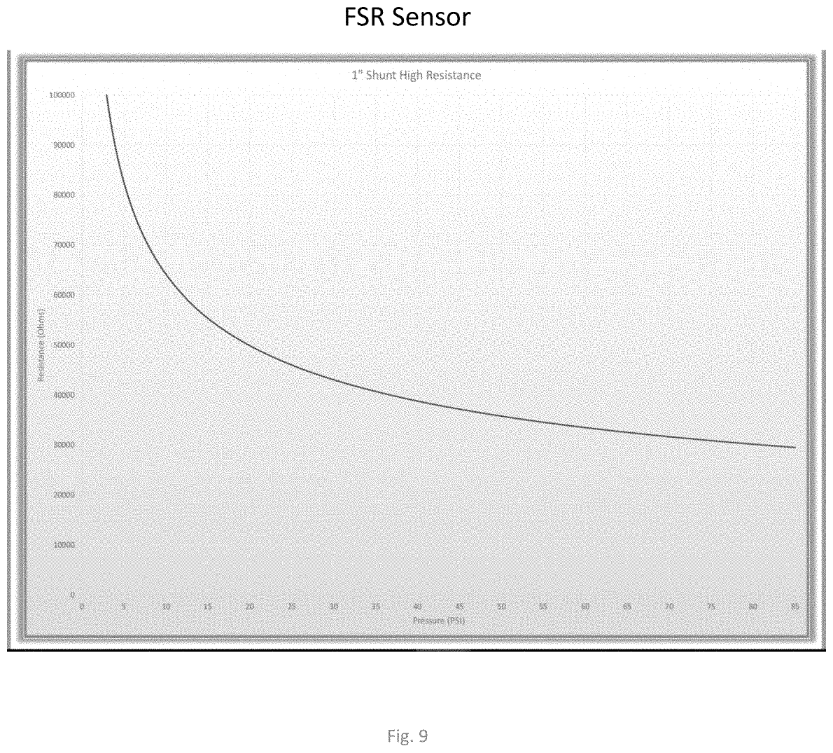

FSR 106 has a variable resistance as a function of applied pressure. The FSR is made of 2 layers 106a & 106d separated by spacer 106b. Layer 106a is the active area having Active Elements dots, plastic spacer 106b has air vent 106c. Layer 106d is made of a conductive film and a flexible substrate. The more one presses the device, more of those Active Element dots on 106a touch the semiconductor decreasing the resistance. When there is no pressure, the sensor looks like an infinite resistor (open circuit), as the pressure increases, the resistance decreases (circuit closes) (see FIG. 9).

As explained above, comparator 109 (FIG. 4b) compares the magnitudes of two voltage inputs. Resistors' predetermined reference voltage is connected to negative entrance of compactor 109.

When circuit is stable, the output is 0 volt and buzzer is on “off” position. When sensor is pressed, voltage in positive entrance of comparator 109 changes. The higher the pressure gets, so does the voltage in positive entrance of comparator 109. When voltage in positive entrance of comparator 109 passed the predetermined reference voltage, comparator 109 outlets changes from 0 to 3 volts (battery 108 voltage) and buzzer 111 is turned on (FIG. 4b). (See table 1 that refers to FIG. 6)

TABLE 1

| Item | Value | Description |
|---|---|---|
| FSR | High | Force Sensing Resistors |
| | resistance | |
| R1 | 50 Kohm | Used to tune the sensitive of the |
| | | system |
| R2 | 2.2 Kohm | Reference Voltage |
| R3 | 2.2 Kohm | Reference Voltage |
| IC1 | LMV321 | Comparator |
| Buzzer | HS-123B | The buzzer will be active when the |
| | | comparator output will be ‘ON’. |
| Battery | CR2032 | Battery 3 Volts |

The predetermined pressure for FSR 106 to close circuit as explained above is 50 kg, based on numerous researches detailed above. It was proved that, in order to effectively reach, patients' chest pressure of 50 kg., user shall have to get as deep as 51 mm in over 50% of tested patients. See tables 2 & 3:

With the aim of saving lives and increasing the survival rates following a cardiac arrest, the device has to be widely distributed and used. With this in mind, the device was designed to be easy to use, small dimensional and affordable.

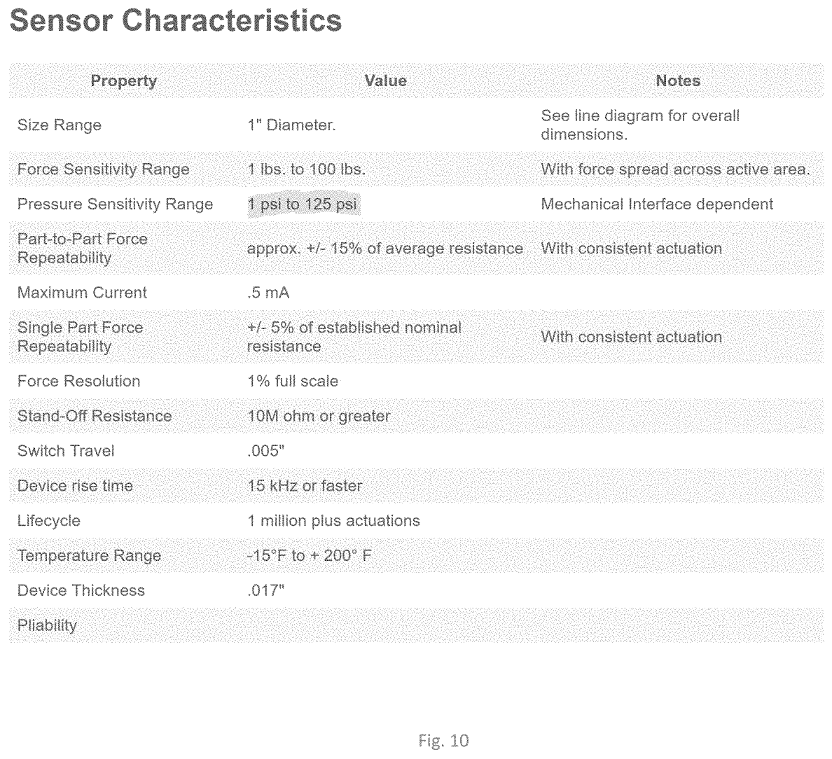

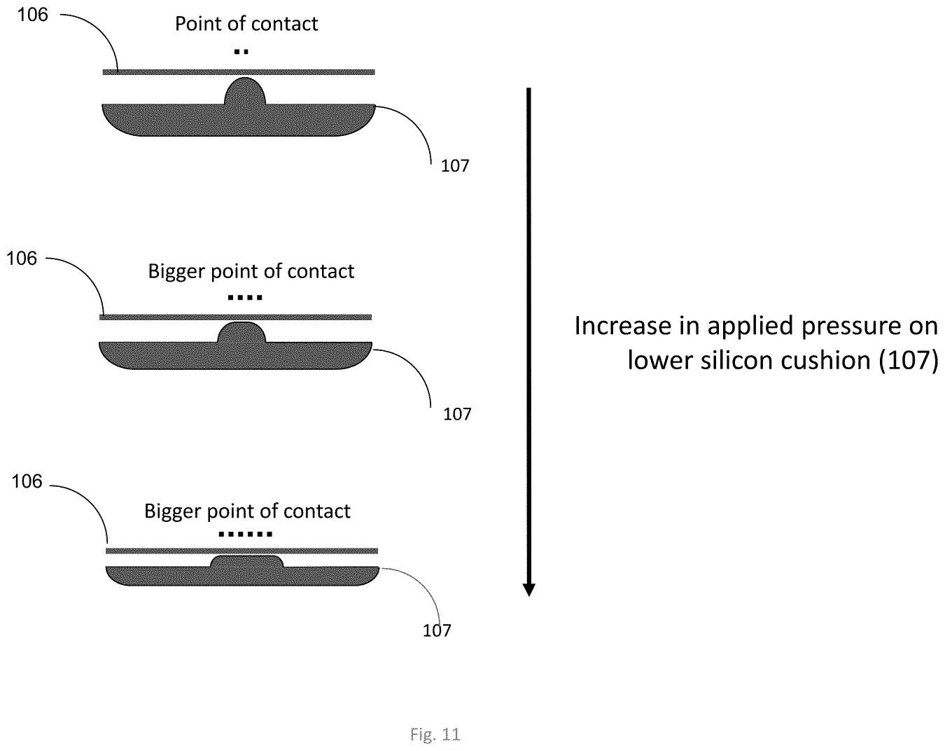

As mentioned above, a change (decrease) in the FSR resistance is achieved with increasing force applied on it. As seen in FIG. 10 (Sensor Characteristics) the sensor's ‘Pressure Sensitivity Range’ (highlighted in yellow) is 1 to 125 PSI (0.07 kg/cm²-8.78 kg/cm²). Yet, a thorough examination of the FSR resistance-pressure curve (FIG. 8) shows that the actual sensitivity range is even lower: 1-80 PSI (0.07 kg/cm²-5.62 kg/cm²) as at values above 80 PSI the curve is near constant.

The ranges of the FSR are much lower than needed according to CPR guidelines for effective chest compressions (50 kg).

Choosing FSR that would endure higher weights (50 kg as needed) will make the whole device not affordable to the end user.

A special mechanic structure combined with specific material's specifications as used in our device (silicon hardness level and compression capability) causes partial absorption of applied pressure as well as gradual distribution of the remaining pressure on the FSR. This allows the FSR in question to work under applied pressure of 50 kg.

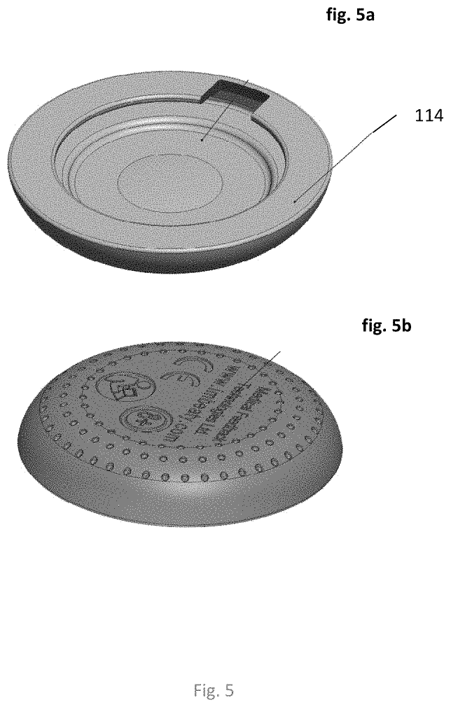

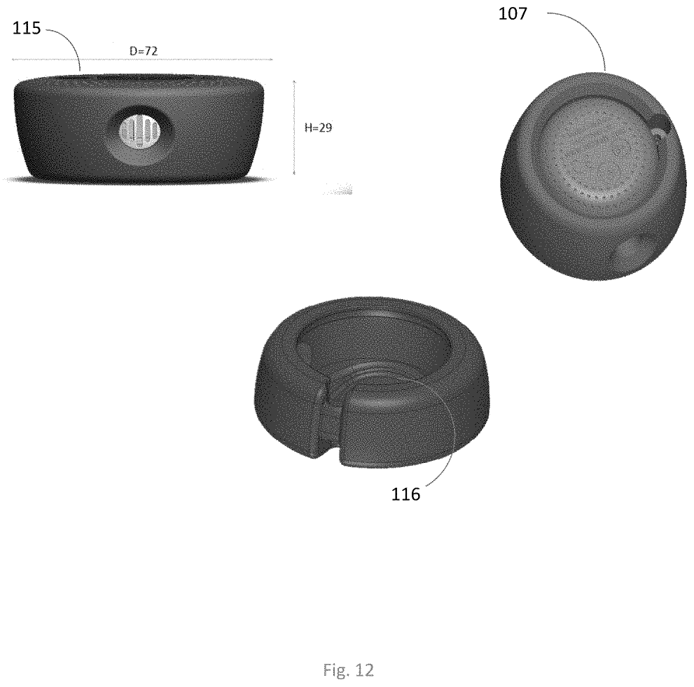

As may be observed in FIG. 11, when compression is made by the user, the silicon cushion which comes in direct contact with patient's chest, absorbs certain amount of the pressure due to its compressibility. At a certain point, a circular curved elevation (made of same compressible silicon material) in inner part of cushion 107 (FIG. 5) meets the FSR and is being compressed against it. The more pressure is applied, the more it changes its spatial structure (becoming flat) and comes in more contact with FSR 106 (gradual pressure) allowing the use of FSR 106 under applied pressure of 50 kg. Using an FSR with higher ‘Pressure Sensitivity Range’ is not cost-effective and will not allow its wide spread among the general population thus increasing the chance of using it in real time (see FIG. 10)

If the elevation in inner silicon cushion 114 is flat (not curved), the pressure would have to be applied overall FSR surface at one time rather than gradually, thus preventing the buildup of a pressure equivalent to 50 kg.

A Silicone adapter 115 of about 7.2 cm diameter is provided with each device and may be used at user's choice and preference (FIG. 12).

Adapter 115 is made of soft silicone material. The upper part of adapter 115 is flat while it's bottom part 116 contains a hollow opening for the insertion of the original small device. Due to a larger surface area, adapter 115 increases user's comfort when prolonged CPR is required (rural areas, medical teams etc.)

Silicone adapter 115 enables the use of the device in hospital where prolonged CPR is required, maintaining the principles of the simplicity and cost-effectiveness of original device.

1. A portable medical device for lay rescuers and first aiders as part of “survival chain” in cardiac arrest scenario built to fit between user's palm and patient chest to be applied on middle of patient's chest, returning audible feedback with every correct chest compression provided, comprising:
an upper part made of soft material to ergonomically fit human palm, glued to a solid upper cover; and
a picture or a schematic drawing placed on its upper part indicating the correct place on patient chest where device is to be placed; and
An upper lid located under the soft layer made of solid material capable of enduring high pressure, connected to the other parts of the device by a rotatory closing system; and
a lower lid made of solid material; and
A printed electronic circuit (PCB) located on the solid lower lid comprising a comparator comparing one analogue voltage level with another analogue voltage level or some preset reference voltage producing an output signal based on voltage comparison; Printed circuit and Sensors; and
electronic components assembled on top of the printed electronic circuit; and
a Force-sensitive resistor (FSR) sensor comprising three layers attached to the rear side of lower lid in a niche and whereas one layer comprises active element dots; and
A cushion made of soft concave material having a circular curved elevation made of same material located in lower part of the device being in contact with patient's chest.

2. A portable device according to claim 1 wherein the solid upper lid may be manufactured by plastic injection into a three-dimensional printer.

3. A portable device according to claim 1 wherein the curved cushion's inner part having no contact with patient's chest, is located about a millimeter away from sensor and when causing pressure on patient's chest the curved cushion is compressed gradually touching sensor and activating the electric circuit.

4. A portable device according to claim 1 wherein FSR has a variable resistance as function of applied pressure.

5. A small portable device according to claim 4 wherein FSR is made of two layers separated by a spacer.

6. A portable device according to claim 4 wherein the layer of the FSR is the active area having active element dots, solid spacer has air vent and layer is made of a conductive film and a flexible substrate.

7. FSR according to claim 4 wherein the more one presses, the more of the active element dots touch the semiconductor reducing resistance.

8. FSR according to claim 4 wherein with no pressure, the sensor looks like an infinite resistor (open circuit) and as pressure increases, resistance reduces.

9. A portable device according to claim 1 wherein comparator compares magnitudes of two voltage inputs and resistors' predetermined reference voltage is connected to negative entrance of compactor.

10. A comparator according to claim 9 wherein when circuit is stable, the output is 0 volt and buzzer is on “off” position and when sensor is pressed, voltage in positive entrance of comparator changes and the higher the pressure gets, so does the voltage in positive entrance of comparator; and when voltage in positive entrance of comparator passed the predetermined reference voltage, comparators' outlet changes from 0 to 3 volts and buzzer is turned on.

11. A comparator according to claim 9 wherein predetermined pressure for FSR to close circuit is 50 kg.

12. A portable device according to claim 1 having a suitable silicone adapter wherein the upper part of the adapter is flat, and its bottom part contains a hollow opening for the portable device.
